(19) United States
(12) Patent Application Publication
(10) Pub. No.: US 2011/0220360 A1
(43) Pub. Date: Sep. 15, 2011

(54) APPLICATION OF ALKALINE FLUIDS FOR POST-FLUSH OR POST-TREATMENT OF A STIMULATED SANDSTONE MATRIX

(76) Inventors: Thomas Lindvig, Tulsa, OK (US); Murtaza Ziauddin, Katy, TX (US); Michael J. Fuller, Houston, TX (US)

(21) Appl. No.: 12/722,604

(22) Filed: Mar. 12, 2010

(51) Int. Cl. E21B 43/25; E21B 43/16; C09K 8/00; C09K 8/40; C09K 8/60; C09K 8/68

(52) U.S. Cl. 166/305.1; 507/267

(57) ABSTRACT

Apparatus and method for treating a subterranean formation including forming a first fluid comprising low pH, introducing the first fluid into a subterranean formation, forming a second fluid comprising high pH, and introducing the second fluid into the formation. Apparatus and method for treating a subterranean formation including introducing a acidizing fluid into a subterranean formation, introducing an inert spacer into the formation, introducing an alkaline fluid into the formation, and introducing a brine or a solvent overflush fluid.

### FIELD OF THE INVENTION

This invention relates to methods and fluids used in treating a subterranean formation. In particular, the invention relates to the methods of use of alkaline fluids as one stage for subterranean formation surface treatment.

### BACKGROUND

The statements in this section merely provide background information related to the present disclosure and may not constitute prior art.

This invention relates to the techniques used for stimulating hydrocarbon-bearing formations—i.e., to increase the production of oil/gas from the formation and more particularly, to a process for utilizing fluids for fracture stimulation treatments.

Hydrocarbons (oil, natural gas, etc.) are obtained from a subterranean geologic formation (i.e., a “reservoir”) by drilling a well that penetrates the hydrocarbon-bearing formation and thus causing a pressure gradient that forces the fluid to flow from the reservoir to the well. Often, a well production is limited by poor permeability either due to naturally tight formations or due to formation damages typically arising from prior well treatment, such as drilling, cleaning etc.

To increase the productivity of a reservoir, it is common to perform a well stimulation. A common stimulation technique is hydraulically fracturing a formation penetrated by a wellbore. The common objective of fracturing is to mechanically bypass near wellbore damage in the porosity of the formation. Hydraulic fracturing typically consists of pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, proppant particles are added to the fluid to form a slurry that is pumped into the fracture to prevent it from closing when the pumping pressure is released.

Matrix treatments in subterranean formations typically employ sequences and mixtures of acids to improve the permeability of a formation. In sandstones, sequences of acids that may comprise mixtures of hydrochloric and hydrofluoric acids, mud acids, to dissolve solids that damage the matrix permeability. The damaging deposits largely comprise aluminosilicates in the form of drilling mud damage, particle invasion, migrating clays and fines, and swelling clays. The fluids used to treat sandstone damaging minerals yield high levels of aluminium in solution through dissolution of aluminosilicates and clays; however, their ability to dissolve silicon is limited because amorphous silica has low solubility at acidic conditions and will often precipitate shortly after clay/aluminosilicate dissolution. Thus, while sandstone matrix treatments often dissolve significant aluminosilicates, the stimulation benefit is partially outweighed by amorphous silica byproduct formation. As sandstone stimulation occurs through removing deposits from the matrix porosity, the most effective sandstone matrix stimulation will dissolve the maximum amount of damaging mineral and deposit minimal amounts of precipitate in the matrix pore-space.

To limit the formation of amorphous silica, less aggressive fluids, often acids with a lower hydrofluoric acid content, are employed when quick dissolution is expected, such as at high temperatures and high concentration of highly reactive alumina silicates. The reaction rates of the clay and acid reactions are reduced, but so is the amorphous silica solubility. The optimum stimulation is a balance between retarding the reaction rates and optimizing amorphous silica solubility. Even at optimum conditions, amorphous silica may form in an acidic hydrofluoric acid environment, which limits the extent to which a sandstone formation may be stimulated.

Amorphous silica has a much higher solubility in alkaline than acidic fluids. Alkaline fluids have previously been studies for clay dissolution and are used for alkaline surfactant and polymer flooding for enhanced oil recovery. A method that utilizes alkaline fluids to remove amorphous silica generated during a sandstone acidizing treatment is needed.

### SUMMARY

Embodiments of the invention relate to apparatus and methods for treating a subterranean formation including forming a first fluid comprising low pH, introducing the first fluid into a subterranean formation, forming a second fluid comprising high pH, and introducing the second fluid into the formation. Embodiments of the invention relate to apparatus and methods for treating a subterranean formation including introducing a acidizing fluid into a subterranean formation, introducing an inert spacer into the formation, introducing an alkaline fluid into the formation, and introducing a brine or a solvent overflush fluid.

### DETAILED DESCRIPTION

Some embodiments relate to methods and apparatus to reduce the likelihood that amorphous silica precipitate residue forms and to optimize aluminosilicate dissolution during a matrix stimulation treatment.

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors have disclosed and enabled the entire range and all points within the range.

Amorphous silica is an inevitable consequence of dissolution of clays/aluminosilicate with HF solutions during matrix stimulation treatments. To optimize the effects of a matrix stimulation, dissolution of damaging minerals and simultaneous minimization of net precipitation, utilizing multiple stages that include a hydrofluoric containing acidic stimulation fluid and an alkaline fluid is desirable.

Sandstone acidizing treatments often involve a sequence of fluids with different functions as a part of the overall matrix treatment. The treatments regularly involve at least one of the following stages: a) brine preflush, most typically with an aqueous solution of ammonium chloride (objective: to displace potassium and sodium cations, known to be incompatible with HF reaction byproducts, from near wellbore); b) acidic preflush (objective: to dissolve calcium minerals such as calcium carbonate, known to precipitate as calcium fluoride when exposed to HF, from near wellbore); c) HF-containing fluid (such as mud acid; objective: to dissolve aluminosilicate minerals); d) brine or acidic postflush/overflush (objective: to displace HF reaction byproducts which may precipitate away from near wellbore region). Sandstone acidizing in long intervals may repeat this sequence of fluids several iterations, optionally separated by diverter stages. While the postflush after the HF stage is intended to minimize precipitation of amorphous silica, this precipitate is inevitable and may still be detrimental to the overall stimulation result.

Following an acidic treatment of sandstone with alkaline fluid stage. As alkaline fluids are known to exhibit high solubility toward amorphous silica (a precipitate of sandstone acidizing), its inclusion as a stage after HF fluid may lead to overall reduction in amorphous silica and an overall improvement in stimulation (compared to treatments lacking alkaline stage). The alkaline fluids may include aqueous solutions (>pH 11, most preferably >pH 11.5, optionally pH>12) of bases; these may include sodium hydroxide, potassium hydroxide, ammonium hydroxide, as nonlimiting examples. These may also include high-pH solutions of organic acids or chelating agents, which have stronger chelating properties at high pH values.

In field applications the alkaline stage may be injected as a postflush at the end of the treatment. The alkaline stage may also be injected after HF stage followed by an inert overflush, to displace the alkaline stage away from the near wellbore region. In some embodiments, the alkaline fluid stage may be introduced before an acidic treatment so that high pH fluids contact silica precipitates during flow back and dissolve the precipitate. Injecting the alkaline fluid before the acidic fluid helps keep the fluids isolated—during flowback, the spent acidic fluids will be produced first and then the formation would be contacted with the alkaline fluids. The alkaline fluids will provide additional clean-up. The spent fluids will be produced out of the formation and will experience minimal, if any, mixing in the formation.

Spacers may also help isolate the fluids. In some embodiments, other fluid delivery methods in which the fluids are separated by phase separation, such as emulsion, micro-droplets, or chemical equilibrium may be employed.

For logistical considerations due to acid reactions with high-pH alkaline solutions, it may be preferable to separate acid and alkaline stages by an inert spacer that is compatible with both fluids and the formation. The spacer may prevent problems that could occur when the acid and alkaline fluids are mixed, including excessive heating and scale formation. Several sequences are therefore proposed as possible preferred means of application of the fluids of current invention. Preferably, injection sequence may include: 1) sandstone acidizing fluids (including brine, acid preflush, HF-fluid, and optional overflush), 2) inert spacer, 3) alkaline fluid stage; 4) brine or solvent overflush fluid. Alternatively, in the event of long intervals, this sequence may be repeated several times as follows: 1) sandstone acidizing fluids; 2) inert spacer; 3) alkaline postflush; 4) inert overflush; 5) diverter; 6) repeat above sequence. Alternatively, in long treated intervals, the sandstone acids and diverter may be repeated several times in sequence with alkaline overflush only being injected in the final stages as follows: 1) sandstone acidizing fluids; 2) diverter stages in sequence; 3) repeat above sequence; 4) inert spacer; 5) alkaline stage; 6) inert overflush.

The fluids used as spacer or post-alkaline overflush may include neutral solutions of brine (most preferably ammonium chloride); aqueous solutions of mutual solvent (such as EGMBE or DPME) in brine; diverter stages (including foamed brines, aqueous solutions of viscoelastic surfactant in brine, and aqueous solutions of bridging agent or external diverter); or hydrocarbon stages. The most preferable spacer fluids would include fluids that exhibit high miscibility/compatibility with both the acidic fluids and alkaline fluids. In some embodiments, the diverter stage and alkaline stage may be combined.

In order to realize the benefits of the alkaline stage, extended shut-in may be necessary before flowing back the stimulation fluids depending on the reaction kinetics of the alkaline stage with silica minerals at the bottomhole temperature.

An alternative means of execution of the alkaline stage may involve injection of the alkaline stage only after flowback of the spent sandstone acidizing fluids. An optional flow-back can also be carried out after the acid stage, the alkaline stage can be pumped straight after the acid flowback with no need for a spacer stage. Flowback may be altogether omitted in injection wells to reduce the potential risk of pushing amorphous silica and other solids towards the near-wellbore region, where it has a more damaging effect than when pushed deeper into the formation.

Addition of chemical additives to the acid can be used to modify the morphology of the deposited amorphous silica to enable faster dissolution during the alkaline stage. In particular, the use of nucleation inhibitors that cause smaller particles to form with a higher specific surface area are expected to increase the dissolution rate during the alkaline stage and shut-in.

Addition of chemical additives to the spacer can be used to minimize the risk of scale formation when fluid mixing occurs. The use of chelants to prevent the formation of scales containing di- and trivalent cations, but other chemicals could be used as well. Chelants have proven useful in moderately and slightly acidic stimulation fluids, but they are even more effective at alkaline conditions. Polymers may also be selected to improve displacement of acid residue. Surfactants may be added to impart preferential wetting. Viscoelastic surfactants may be added optionally to impart viscosity. In some embodiments, tracer species may be introduced in each fluid stage to allow tracking of fluid placement and timing of injection of the subsequent stages. The preferred fluids may also include other additives common in fluids used in subterranean stimulation, including bactericides, corrosion inhibitors and inhibitor aids, clay stabilizers, shale stabilizers, demulsifiers, and scale inhibitors, for example.

The alkaline stage of the treatment has a consolidating effect as an additional benefit. The treatment can be designed to improve consolidation in poorly consolidated formations by adjusting parameters such as fluid formulation, shut-in time, etc.

### EXAMPLES

Solubility testing was conducted on lab stock kaolin samples and sandstone core samples after sequential treatment with 9/1 mud acid and high-pH aqueous solutions of either NaOH, NH₄OH or diammonium ethylenediaminetetraacetic acid (EDTA). This testing validates possible higher pH formulations as an overflush to regular mud acid treatments toward dissolution of amorphous silica precipitate.

To perform this testing, the following steps were followed.
1. Sample of kaolin or ground sandstone core is weighed and placed into a beaker.
2. Pour in 200 ml of 9/1 mud acid and place the beaker into the water bath at 200 F.
3. Leave the beaker in the water bath at temperature for four hours. Stir the mixture in every 20 minute intervals throughout the water bath treatment.
4. After four hours, decant the mud acid solution and rinse with 5 percent NH₄Cl brine. Decant away rinse brine.
5. Dry the remaining residue in the oven and reweigh the sample to obtain the remaining residue weight.
6. To the remaining solid, add in 200 ml NaOH solution and place again in the water bath for four hours.
7. After four hours, decant the NaOH solution and rinse with 5 percent NH₄Cl brine solution.
8. Dry the sample and reweigh to obtain the final weight.
9. Repeat the test to replace NaOH with NH₄OH solution and DBTA solution (pH adjusted with NH₄OH).

TABLE 1
XRD Analysis on Sandstone Sample

| | | | Composition Amount |
|---|---|---|---|
| Minerals Detected | | | in % By Weight of |
| Class | Group | Mineral | 1-015S1 |
| Silicates | Quartz | Quartz | 82.0 |
| | Feldspars | Microcline | 4.0 |
| | | Albite | 5.6 |
| | Clays | Chlorite | 1.8 |
| | | Illite | 3.3 |
| | | Kaolinite | 1.8 |
| Carbonate | Calcite | Calcite | — |
| | Dolomite | Dolomite | — |
| | Calcite | Siderite | 1.1 |
| Oxides | Spinel | Magnetite | 0.3 |

X-ray diffraction was used to analyze sandstone samples and the results are listed in Table 1.

TABLE 2
Solubility in 9/1 Mud Acid and NaOH

| | % Solubility | | | |
|---|---|---|---|---|
| | Kaolin Sample | | Sandstone Core Sample | |
| | | Total %- | | Total %- |
| Treatment Fluid | Mass (g) | Solubility | Mass | Solubility |
| [Initial Mass] | 10.1041 | — | 5.2318 | — |
| 9/1 Mud Acid | 6.6196 | 34.5 | 4.2992 | 17.8 |
| 10 wt % NaOH | 0.5853 | 94.3 | 4.2544 | 18.7 |
| Solution | | | | |
| (pH = 12.69) | | | | |

TABLE 3
Solubility in 9/1 Mud Acid and NH₄OH

| | % Solubility | | | |
|---|---|---|---|---|
| | Kaolin Sample | | Sandstone Core Sample | |
| | | Total %- | | Total %- |
| Treatment Fluid | Mass (g) | Solubility | Mass | Solubility |
| [Initial Mass] | 10.0587 | — | 5.491 | — |
| 9/1 Mud Acid | 6.6011 | 34.4 | 4.5757 | 16.7 |
| 10 wt % NH₄OH | 5.6051 | 44.3 | 4.2881 | 22.1 |
| Solution | | | | |
| (pH = 12.26) | | | | |

TABLE 4
Solubility in 9/1 Mud Acid and 45%
Diammonium-EDTA (pH adjusted)

% Solubility
Kaolin Sample

| | | Total %- |
|---|---|---|
| Treatment Fluid | Mass (g) | Solubility |
| [Initial Mass] | 10.0868 | — |
| 9/1 Mud Acid | 6.312 | 37.4 |
| 45% Diammonium-EDTA (pH | 5.921 | 41.3 |
| Adjusted with NH₄OH) | | |
| (pH = 11.36) | | |

These tables show that a high pH flush is desirable. An optional, but important neutral spacer fluid between the flushes may be needed to avoid heat. Finally, the pH threshold may be tailored for each application, especially those applications above pH of 11.

We claim:

1. A method for treating a subterranean formation, comprising:
forming a first fluid comprising low pH;
introducing the first fluid into a subterranean formation;
forming a second fluid comprising high pH; and
introducing the second fluid into the formation.

2. The method of claim 1, wherein less precipitates form in a formation porosity than the precipitates that would be formed if no second fluid were introduced into the formation.

3. The method of claim 1, wherein the formation comprises sandstone.

4. The method of claim 1, wherein the second fluid does not contain silicate inhibitor.

5. The method of claim 1, wherein the first fluid comprises hydrofluoric acid.

6. The method of claim 1, wherein the second fluid comprises sodium hydroxide, potassium hydroxide, ammonium hydroxide or dibenzoyl-L-tartaric acid or a combination thereof.

7. The method of claim 1, further comprising introducing a spacer between introducing the first and second fluids, wherein the spacer comprises aqueous brine, mutual solvent, foamed brines, viscoelastic surfactant, bridging agent, external diverter, and/or hydrocarbon stages or a mixture thereof.

8. The method of claim 1, wherein the first fluid is introduced into the formation first and the second fluid is introduced into the formation after the first fluid.

9. The method of claim 1, wherein the second fluid is introduced into the formation first and the first fluid is introduced into the formation after the second fluid.

10. The method of claim 1, where the alkaline fluid comprises maleic acid, tartaric acid, citric acid, NTA, HEIDA, HEDTA, EDTA, CyDTA, DTPA, ammonium, lithium, or sodium salts of these acids or mixtures and/or their salts.

11. The method of claim 1, wherein the first or second fluid comprises an emulsion or micro-droplets.

12. The method of claim 1, wherein the first or second fluid comprises a tracer.

13. A method for treating a subterranean formation, comprising:
introducing a acidizing fluid into a subterranean formation;
introducing an inert spacer into the formation;
introducing an alkaline fluid into the formation; and
introducing an inert overflush into the formation.

14. The method of claim 13, wherein the acidizing fluid comprises a sequential injection in any order of the following stages: brine, acid preflush, and fluid that contains hydrofluoric acid.

15. The method of claim 14, wherein the acidizing fluid further comprises overflush.

16. A method for treating a subterranean formation, comprising:
introducing a acidizing fluid into a subterranean formation;
introducing an inert spacer into the formation;
introducing an alkaline fluid into the formation; and
introducing a solvent overflush fluid.

17. The method of claim 16, wherein the alkaline fluid comprises sodium hydroxide, potassium hydroxide, caustic, lithium hydroxide, cesium hydroxide, ammonium hydroxide or organic acids modified to high-pH or a combination thereof.

18. The method of claim 17, wherein the organic acid is a chelating agent.

19. The method of claim 17, wherein the organic acid is modified to high PH by strong base chemicals.

20. A method for treating a subterranean formation, comprising:
introducing a acidizing fluid or series of fluids into a subterranean formation;
flowing the spent acidizing fluids to the surface after acid injection;
introducing an alkaline fluid into the acidized formation; and
introducing a solvent overflush fluid.
